(19) United States
(12) Patent Application Publication
(10) Pub. No.: US 2025/0276406 A1
(43) Pub. Date: Sep. 4, 2025

(54) LASER PROCESSING APPARATUS AND LASER PROCESSING METHOD

(71) Applicant: DISCO CORPORATION, Tokyo (JP)

(72) Inventor: Yuta YOSHIDA, Tokyo (JP)

(21) Appl. No.: 19/052,424

(22) Filed: Feb. 13, 2025

(30) Foreign Application Priority Data
Feb. 29, 2024 (JP) 2024-030253

(51) Int. Cl. B23K 26/067; B23K 26/06

(52) U.S. Cl. CPC B23K 26/0676; B23K 26/0648; B23K 26/0652

(57) ABSTRACT

A laser processing apparatus includes: a holding unit configured to hold a workpiece; an oscillator configured to generate a laser beam; a splitter element configured to split the laser beam generated by the oscillator into a first laser beam and a second laser beam; a rotation mechanism configured to rotate the splitter element about an axis passing through a center of the splitter element; and a focusing unit including a focusing lens configured to focus the first laser beam split by the splitter element onto the workpiece held by the holding unit and to focus the second laser beam split by the splitter element onto the workpiece held by the holding unit.

### CROSS-REFERENCE TO RELATED APPLICATION(S)

The present application claims priority to and incorporates by reference the entire contents of Japanese Patent Application No. 2024-030253 filed in Japan on Feb. 29, 2024.

### BACKGROUND

The present disclosure relates to a laser processing apparatus and a laser processing method.

In order to improve productivity in laser processing, there has been proposed a laser processing apparatus capable of simultaneously processing a plurality of scheduled processing lines of a workpiece by simultaneously irradiating the plurality of scheduled processing lines with laser beams (refer to JP 2008-290086 A, for example).

The conventional processing apparatus has a configuration including a complicated mechanism for splitting a laser beam and a complicated mechanism for adjusting intervals between focusing points of split laser beams, having room for improvement.

### SUMMARY

A laser processing apparatus according to one aspect of the present disclosure includes: a holding unit configured to hold a workpiece; an oscillator configured to generate a laser beam; a splitter element configured to split the laser beam generated by the oscillator into a first laser beam and a second laser beam; a rotation mechanism configured to rotate the splitter element about an axis passing through a center of the splitter element; and a focusing unit including a focusing lens configured to focus the first laser beam split by the splitter element onto the workpiece held by the holding unit and to focus the second laser beam split by the splitter element onto the workpiece held by the holding unit.

A laser processing method according to one aspect of the present disclosure is of processing a workpiece on which a plurality of scheduled processing lines extending in a first direction is set. The method includes: holding a workpiece by a holding unit; performing laser processing along the scheduled processing lines on the workpiece by splitting a laser beam generated by an oscillator into a first laser beam and a second laser beam by a splitter element, and relatively moving a focusing unit and the holding unit in a first direction while focusing light on the workpiece held by the holding unit using the first laser beam and the second laser beam, the performing the laser processing including positioning a focusing point of the first laser beam on a first scheduled processing line, positioning a focusing point of the second laser beam on a second scheduled processing line different from the first scheduled processing line, and emitting the first laser beam along the first scheduled processing line while emitting the second laser beam along the second scheduled processing line; and at least before performing the laser processing, adjusting an interval between the focusing point of the first laser beam and the focusing point of the second laser beam by rotating the splitter element based on a distance between the focusing point of the first laser beam and the focusing point of the second laser beam in a second direction orthogonal to the first direction.

### BRIEF DESCRIPTION OF THE DRAWINGS

FIG. 1 is a perspective view illustrating a configuration example of a laser processing apparatus according to a first embodiment;

FIG. 2 is a perspective view illustrating a workpiece to be processed by the laser processing apparatus illustrated in FIG. 1;

FIG. 3 is a diagram illustrating a configuration of a laser beam irradiation unit of the laser processing apparatus illustrated in FIG. 2;

FIG. 4 is a plan view illustrating an example of a focusing point of a first laser beam, a focusing point of a second laser beam, and the like in the laser beam irradiation unit illustrated in FIG. 3;

FIG. 5 is a plan view illustrating another example of the focusing point of the first laser beam, the focusing point of the second laser beam, and the like in the laser beam irradiation unit illustrated in FIG. 3;

FIG. 6 is a flowchart illustrating a flow of a laser processing method according to the first embodiment;

FIG. 7 is a plan view of the workpiece illustrating an example of a trajectory of the focusing point of the first laser beam and a trajectory of the focusing point of the second laser beam in a laser processing step of the laser processing method illustrated in FIG. 6; and

FIG. 8 is a diagram illustrating a modification of the laser beam irradiation unit illustrated in FIG. 3.

### DETAILED DESCRIPTION

Preferred embodiments (embodiments) for carrying out the present disclosure will be described in detail with reference to the drawings. The present invention is not limited by the description in the following embodiments. In addition, the constituent elements described below include those that can be easily assumed by those skilled in the art and those that are substantially the same. Furthermore, the configurations described below can be appropriately combined with each other. In addition, various omissions, substitutions, or alterations in the configuration can be made without departing from the scope and spirits of the present invention.

### First Embodiment

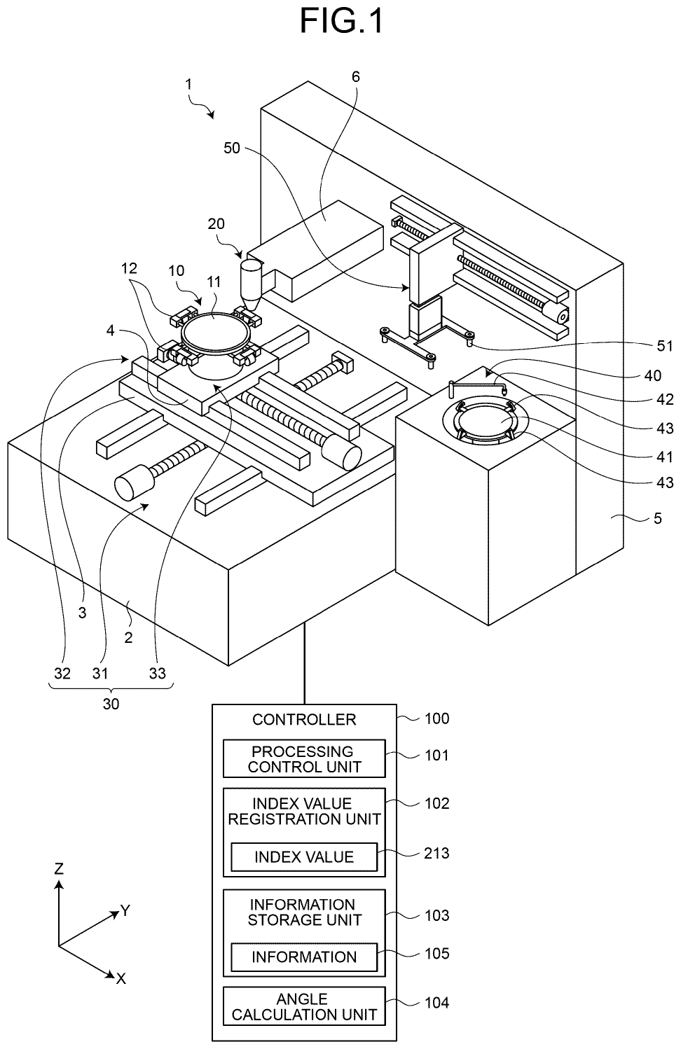

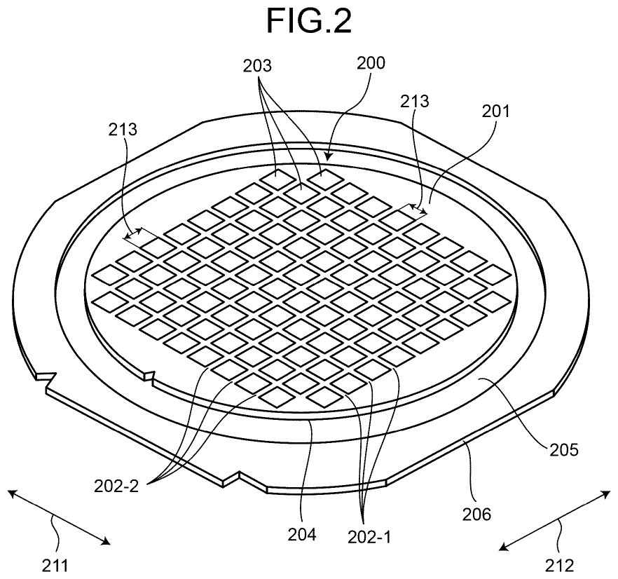

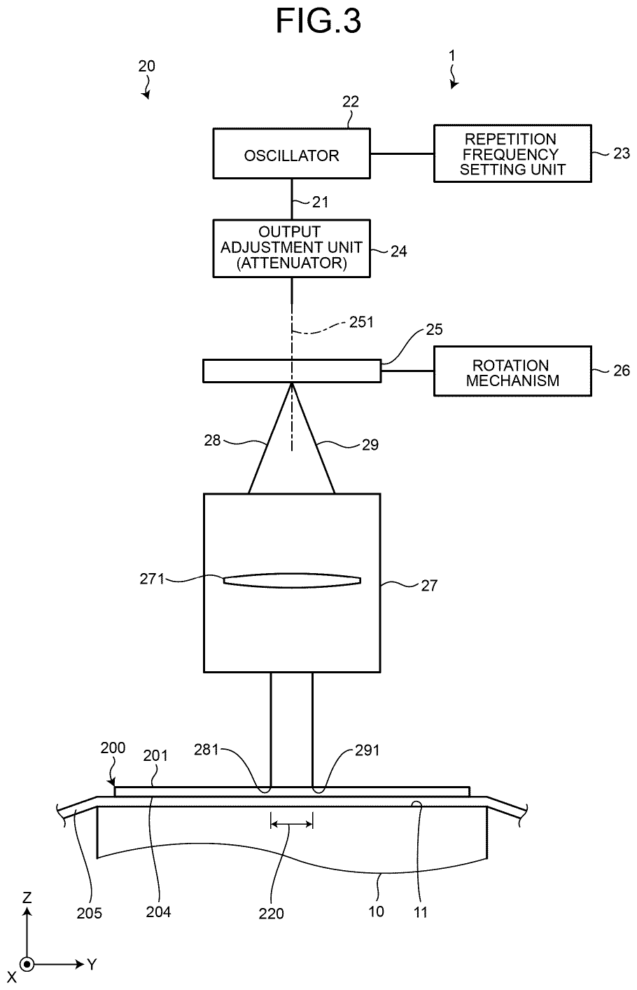

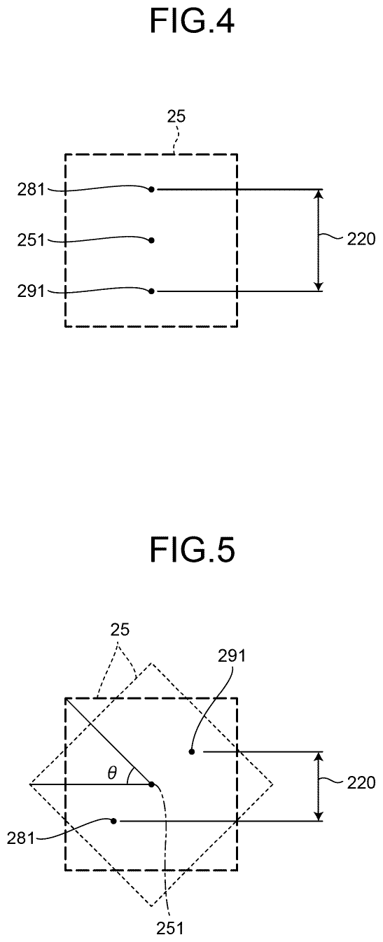

A laser processing apparatus according to a first embodiment of the present disclosure will be described with reference to the drawings. FIG. 1 is a perspective view illustrating a configuration example of a laser processing apparatus according to a first embodiment. FIG. 2 is a perspective view illustrating a workpiece to be processed by the laser processing apparatus illustrated in FIG. 1. FIG. 3 is a diagram illustrating a configuration of a laser beam irradiation unit of the laser processing apparatus illustrated in FIG. 2. FIG. 4 is a plan view illustrating an example of a focusing point of a first laser beam, a focusing point of a second laser beam, and the like of the laser beam irradiation unit illustrated in FIG. 3. FIG. 5 is a plan view illustrating another example of the focusing point of the first laser beam, the focusing point of the second laser beam, and the like of the laser beam irradiation unit illustrated in FIG. 3.

### Workpiece

A laser processing apparatus 1 illustrated in FIG. 1 according to the first embodiment is a processing apparatus that processes a workpiece 200 illustrated in FIG. 2. Examples of the workpiece 200 to be processed by the laser processing apparatus 1 illustrated in FIG. 1 according to the first embodiment include wafers such as a disk-shaped semiconductor wafer using a silicon substrate, a sapphire substrate, a gallium substrate, a SiC substrate, or the like as a substrate, or an optical device wafer.

In the first embodiment, as illustrated in FIG. 2, the workpiece 200 has a configuration including a plurality of devices 203 formed in a region defined by scheduled processing lines 202-1, being lines parallel to each other and parallel to a first direction 211 on a front surface 201, and defined by scheduled processing lines 202-2, being lines parallel to a second direction 212 orthogonal to the first direction 211. In this manner, the plurality of scheduled processing lines 202-1 extending in the first direction 211 and the plurality of scheduled processing lines 202-2 extending in the second direction 212 are set in the workpiece 200. The device 203 is, for example, an integrated circuit such as an Integrated Circuit (IC) or a Large Scale Integration (LSI), an image sensor such as a Charge Coupled Device (CCD) or a Complementary Metal Oxide Semiconductor (CMOS), or a memory device (semiconductor storage device).

In the first embodiment, the workpiece 200 is supported in an opening inside a frame 206 having an annular shape, by allowing a central portion of a tape 205 having a larger diameter than the workpiece 200 and having the frame 206 stuck to an outer edge, to stick to a back surface 204, being a surface on a back side of the front surface 201. In the present disclosure, the workpiece 200 is not limited to the form of being stuck to the tape 205. In the present disclosure, the workpiece 200 need not have the scheduled processing line 202-1, 202-2 or the device 203, formed on the front surface 201.

### Laser Processing Apparatus

As illustrated in FIG. 1, the laser processing apparatus 1 according to the first embodiment includes a holding unit 10, a movement unit 30, a laser beam irradiation unit 20, an imaging unit (not illustrated), a cleaning unit 40, a transfer unit 50, and a controller 100.

The holding unit 10 has a disk shape, and has a holding surface 11, being flat in the horizontal direction and configured to hold the workpiece 200, formed of a material such as porous ceramic. In addition, the holding unit 10 is movable by the movement unit 30 across two regions: a processing region, being a region below the laser beam irradiation unit 20; and a loading/unloading region, being a region separated from the lower side of the laser beam irradiation unit 20 and used for loading/unloading of the workpiece 200.

The holding unit 10 is connected to a vacuum suction source (not illustrated), and uses suction from the vacuum suction source to suck and hold the workpiece 200 placed on the holding surface 11. In the first embodiment, the holding unit 10 sucks and holds the back surface 204 side of the workpiece 200 via the tape 205. As illustrated in FIG. 1, a plurality of clamping portions 12 for clamping the frame 206 is provided around the holding unit 10.

The movement unit 30 relatively moves the holding unit 10 and the laser beam irradiation unit 20. The movement unit 30 includes at least: a Y-axis movement unit 31, being a stepped feed unit that moves the holding unit 10 in the Y-axis direction parallel to the horizontal direction; an X-axis movement unit 32, being a processing feed unit that moves the holding unit 10 in the X-axis direction parallel to the horizontal direction and orthogonal to the Y-axis direction; and a rotary movement unit 33, being a unit that rotates the holding unit 10 about an axis parallel to the Z-axis direction parallel to the vertical direction.

The Y-axis movement unit 31 is installed in an apparatus body 2, and moves a movement plate 3 equipped with the X-axis movement unit 32 in the Y-axis direction, thereby moving the holding unit 10 in the Y-axis direction. The X-axis movement unit 32 is installed on the movement plate 3, and moves a second movement plate 4 equipped with the rotary movement unit 33 in the X-axis direction, thereby moving the holding unit 10 in the X-axis direction. The rotary movement unit 33 is installed on the second movement plate 4 and supports the holding unit 10 to rotate the holding unit 10 about the axis.

The Y-axis movement unit 31 moves the X-axis movement unit 32, the second movement plate 4, the rotary movement unit 33, and the holding unit 10 in the Y-axis direction, together with the movement plate 3. The X-axis movement unit 32 moves the rotary movement unit 33 and the holding unit 10 in the X-axis direction, together with the second movement plate 4.

The Y-axis movement unit 31 and the X-axis movement unit 32 include: a known ball screw rotatably provided around the axis; a known motor that rotates the ball screw around the axis; and a known guide rail that movably supports the movement plates 3 and 4 in the X-axis direction or the Y-axis direction. The rotary movement unit 33 includes a member such as a known motor that rotates the holding unit 10 about the axis.

As illustrated in FIG. 1, the laser beam irradiation unit 20 has its partial portion provided at a distal end of a support column 6 whose proximal end portion is supported by an upright wall 5 erected from an end of the apparatus body 2 in the Y axis direction. The laser beam irradiation unit 20 irradiates the workpiece 200 held by the holding unit 10 with laser beams 28 and 29 (illustrated in FIG. 3) to perform laser processing.

As illustrated in FIG. 3, the laser beam irradiation unit 20 includes an oscillator 22, a repetition frequency setting unit 23, an output adjustment unit 24, a splitter element 25, a rotation mechanism 26, and a focusing unit 27. The oscillator 22 is a device that generates and oscillates a laser beam 21, being a pulsed beam with a wavelength absorbable by the workpiece 200. While the laser beam 21 has a wavelength absorbable by the workpiece 200 in the first embodiment, the laser beam may have a wavelength transparent to the workpiece 200 in the present disclosure, The repetition frequency setting unit 23 sets the repetition frequency of the laser beam 21 being a pulsed beam oscillated by the oscillator 22.

The output adjustment unit 24 adjusts the output of the laser beam 21 oscillated by the oscillator 22. In the first embodiment, the output adjustment unit 24 is a known attenuator. The splitter element 25 splits the laser beam 21 generated and oscillated by the oscillator 22 into a first laser beam 28 and a second laser beam 29. In the first embodiment, the splitter element 25 splits the laser beam 21 such that the first laser beam 28 and the second laser beam 29 are aligned with each other in the Y-axis direction. In the first embodiment, the splitter element 25 includes a diffractive optical element (DOE) that splits one laser beam 21 into two laser beams, namely, the first laser beam 28 and the second laser beam 29.

The rotation mechanism 26 rotates the splitter element 25 about an optical axis 251 of the laser beam 21 incident on the splitter element 25, being an axis passing through the center of the splitter element 25. In the first embodiment, the rotation mechanism 26 includes a motor or the like that rotates the splitter element 25 about the optical axis 251.

The focusing unit 27 includes a focusing lens 271, which focuses the first laser beam 28 split by the splitter element 25 on the workpiece 200 held by the holding unit 10 and focuses the second laser beam 29 split by the splitter element 25 on the workpiece 200 held by the holding unit 10. In the first embodiment, the focusing lens 271 is a lens referred to as a biconvex lens. In the first embodiment, in addition to the focusing lens 271 being a biconvex lens, the focusing unit 27 further includes: a pair of known convex/concave lenses having convex surfaces facing each other so as to have the focusing lens 271 located between the convex/concave lens pair; a convex/concave lens located between the convex/concave lens on the holding unit 10 side and the focusing lens 271 and having a concave surface facing the focusing lens 271; and a plano-convex lens located between this convex/concave lens and the convex/concave lens on the holding unit 10 side and having a convex surface on the focusing lens 271 side. The focusing unit 27 forms the first laser beam 28 to be perpendicular to the front surface 201 of the workpiece 200, and forms the second laser beam 29 to be perpendicular to the front surface 201 of the workpiece 200.

The laser beam irradiation unit 20 sets the focusing point 281 of the first laser beam 28 and the focusing point 291 of the second laser beam 29 formed by the focusing unit 27 to be beams aligned with each other in the Y-axis direction as illustrated in FIGS. 3 and 4. Furthermore, the laser beam irradiation unit 20 has a configuration in which as the rotation mechanism 26 rotates the splitter element 25 about the optical axis 251, thereby changing an interval 220 in the Y axis direction between the focusing point 281 of the first laser beam 28 and the focusing point 291 of the second laser beam 29, formed by the focusing unit 27, as illustrated in FIGS. 4 and 5. That is, the interval 220 changes depending on an orientation 0 which is a rotation angle of the splitter element 25 around the optical axis 251.

The imaging unit includes an imaging element that images a region to be split on the workpiece 200 before undergoing laser processing, held by the holding unit 10. Examples of the imaging element include a charge-coupled device (CCD) imaging element or a complementary MOS (CMOS) imaging element. The imaging unit captures an image of the workpiece 200 held by the holding unit 10 so as to obtain an image for performing alignment, being an operation of aligning the workpiece 200 and the laser beam irradiation unit 20, and outputs the obtained image to the controller 100.

The cleaning unit 40 cleans the workpiece 200 after undergoing laser processing. The cleaning unit 40 has a disk shape, and includes a spinner table 41 and a cleaning nozzle 42; the spinner table 41 is a table formed of a material such as porous ceramic and having a holding surface being flat in the horizontal direction and configured to hold the workpiece 200. The spinner table 41 is rotated about an axis parallel to the Z-axis direction by a rotary drive source (not illustrated).

The spinner table 41 has its holding surface connected to a vacuum suction source (not illustrated), and sucks and holds the workpiece 200 placed on the holding surface on suction from the vacuum suction source. In the first embodiment, the spinner table 41 sucks and holds the back surface 204 side of the workpiece 200 via the tape 205. In addition, a plurality of clamping portions 43 for clamping the frame 206 is provided around the spinner table 41.

The cleaning nozzle 42 supplies cleaning water (in the first embodiment, pure water) to the front surface 201 of the workpiece 200 held by the spinner table 41 to clean the front surface 201 of the workpiece 200.

The transfer unit 50 transfers the workpiece 200 between the holding unit 10 and the cleaning unit 40. The transfer unit 50 includes a transfer arm 51 that transfers the workpiece 200 between the holding unit 10 and the cleaning unit 40.

The controller 100 controls each component of the laser processing apparatus 1 to cause the laser processing apparatus 1 to perform processing operations onto the workpiece 200. That is, the controller 100 controls at least the rotation mechanism 26. The controller 100 is a computer including: an arithmetic processing apparatus having a microprocessor such as a central processing unit (CPU); a storage device having memory such as Read Only Memory (ROM) or Random Access Memory (RAM); and an input/output interface apparatus. The arithmetic processing apparatus of the controller 100 performs arithmetic processing according to a computer program stored in the storage device, and outputs a control signal for controlling the laser processing apparatus 1 to each component of the laser processing apparatus 1 via the input/output interface apparatus.

The controller 100 is connected to a display unit (not illustrated) including an apparatus such as a liquid crystal display apparatus that displays a state of a processing operation, an image, or the like, and to an input unit (not illustrated) used by an operator to register processing content information or the like. The input unit includes at least one of a touch panel provided on the display unit or an external input apparatus such as a keyboard.

As illustrated in FIG. 1, the controller 100 includes a processing control unit 101, an index value registration unit 102, an information storage unit 103, and an angle calculation unit 104. The processing control unit 101 controls each component of the laser processing apparatus 1 to cause the laser processing apparatus 1 to perform processing operations onto the workpiece 200.

The index value registration unit 102 registers an index value 213. The index value 213 is an interval, in the Y-axis direction, between the position of the focusing point 281 of the first laser beam 28 focused on the front surface 201 of the workpiece 200 and the position of the focusing point 292 of the second laser beam 29 focused on the front surface 201 of the workpiece 200. In the first embodiment, the index value 213 is an interval, in the Y-axis direction, between the focusing points 281 and 291 on the scheduled processing lines 202-1 adjacent to each other and the scheduled processing lines 202-2 adjacent to each other, on the front surfaces 201.

The information storage unit 103 stores information 105. The information 105 indicates a relationship between the orientation 0 (corresponding to the rotation angle) of the splitter element 25 around the optical axis 251 and the interval 220 between the focusing points 281 and 291 in the Y-axis direction. The angle calculation unit 104 calculates the orientation 0 of the splitter element 25 around the optical axis 251 based on the index value 213 registered in the index value registration unit 102 and the information 105 stored in the information storage unit 103.

The functions of the index value registration unit 102 and the information storage unit 103 are implemented by the storage device. The functions of the processing control unit 101 and the angle calculation unit 104 are implemented by arithmetic processing performed by the arithmetic processing apparatus according to a computer program stored in the storage device.

### Laser Processing Method

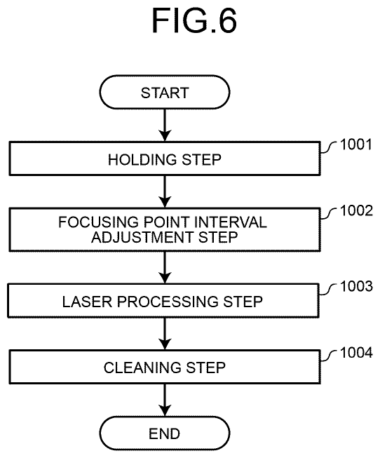

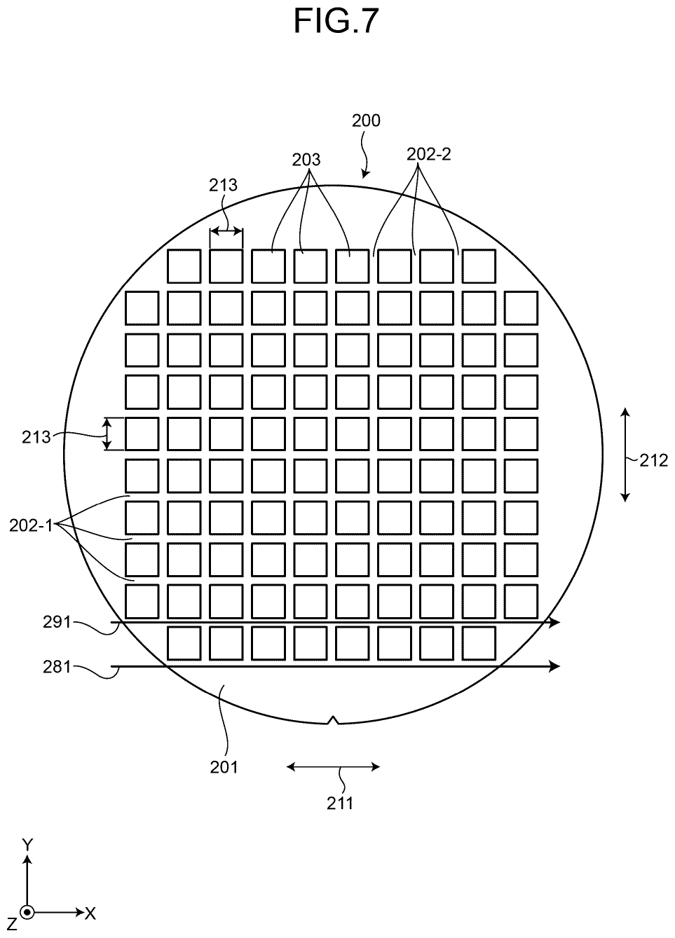

Next, a laser processing method according to the first embodiment will be described. FIG. 6 is a flowchart illustrating a flow of a laser processing method according to the first embodiment. FIG. 7 is a plan view of the workpiece illustrating an example of a trajectory of the focusing point of the first laser beam and a trajectory of the focusing point of the second laser beam in a laser processing step of the laser processing method illustrated in FIG. 6.

The laser processing method is a laser processing method performed on the workpiece 200, as a method of performing laser processing on the workpiece 200. As illustrated in FIG. 6, the laser processing method includes a holding step 1001, a focusing point interval adjustment step 1002, a laser processing step 1003, and a cleaning step 1004.

### Holding Step

The holding step 1001 is a step of holding the workpiece 200 by the holding unit 10. In the holding step 1001, when the processing conditions are registered in the controller 100 by the operator or the like, the workpiece 200 is placed on the holding surface 11 of the holding unit 10 via the tape 205, and the controller 100 receives an instruction to start the processing operation from the operator or the like, the laser processing apparatus 1 starts the processing operation, that is, the holding step 1001. The processing condition includes the index value 213 and the like.

In the holding step 1001 performed by the laser processing apparatus 1 according to the first embodiment, the processing control unit 101 of the controller 100 sucks and holds the back surface 204 side of the workpiece 200 onto the holding surface 11 of the holding unit 10 via the tape 205, and clamps the frame 206 using the clamping portion 12.

### Focusing Point Interval Adjustment Step

The focusing point interval adjustment step 1002, being a step to be implemented at least before performing the laser processing step 1003, is a step of adjusting the interval 220 between the focusing point 281 of the first laser beam 28 and the focusing point 291 of the second laser beam 29 by rotating the splitter element 25 based on the index value 213 being a distance between the focusing point 281 of the first laser beam 28 and the focusing point 291 of the second laser beam 29 in the second direction 212 orthogonal to the first direction 211.

In the first embodiment, in the focusing point interval adjustment step 1002 performed by the laser processing apparatus 1, the angle calculation unit 104 of the controller 100 calculates the orientation 0 of the splitter element 25 around the optical axis 251 based on the index value 213 registered in the index value registration unit 102 and the information 105 stored in the information storage unit 103. In the first embodiment, in the focusing point interval adjustment step 1002 performed by the laser processing apparatus 1, the processing control unit 101 of the controller 100 controls the rotation mechanism 26 to rotate the splitter element 25 around the optical axis 251 so as to achieve the orientation 0 around the optical axis 251 calculated by the angle calculation unit 104, and sets the orientation 0 of the splitter element 25 to the orientation 0 calculated by the angle calculation unit 104. In this manner, in the focusing point interval adjustment step 1002, the processing control unit 101 of the controller 100 controls the rotation mechanism 26 based on the orientation 0 calculated by the angle calculation unit 104.

### Laser Processing Step

The laser processing step 1003 is a step including: splitting the laser beam 21 generated by the oscillator 22 into the first laser beam 28 and the second laser beam 29 by the splitter element 25; and relatively moving the focusing unit 27 and the holding unit 10 in the first direction 211 while focusing light, by the focusing unit 27, on the workpiece 200 held by the holding unit 10 using the first laser beam 28 and the second laser beam 29 so as to perform laser processing along the scheduled processing lines 202-1 and 202-2 on the workpiece 200. In the first embodiment, in the laser processing step 1003 performed by the laser processing apparatus 1, the processing control unit 101 of the controller 100 controls the movement unit 30 to move the holding unit 10 toward a processing region, captures an image of the workpiece 200 with the imaging unit, and performs alignment based on the image captured by the imaging unit.

In the first embodiment, in the alignment, the processing control unit 101 of the controller 100 adjusts the orientation of the holding unit 10 around its axis by the rotary movement unit 33 so that the first direction 211 of the workpiece 200 and the X-axis direction become parallel. Furthermore, in the first embodiment, in the alignment, the processing control unit 101 of the controller 100 controls the movement unit 30, the focusing unit 27, and the like to set the focusing point 281 of the first laser beam 28, on which the laser beam 21 is split by the splitter element 25, on the front surface 201 of any of the scheduled processing lines 202-1 among the plurality of scheduled processing lines 202-1 extending in the first direction 211, and set the focusing point 291 of the second laser beam 29 on the front surface 201 of the scheduled processing line 202-1 adjacent to the scheduled processing line 202-1 on which the focusing point 281 of the first laser beam 28 has been set.

In the first embodiment, in the laser processing step 1003 of the laser processing apparatus 1, the processing control unit 101 of the controller 100 controls the laser beam irradiation unit 20, the movement unit 30, and the like to relatively move the focusing unit 27 and the holding unit 10 of the laser beam irradiation unit 20 in the X-axis direction, that is, in the first direction 211, so as to set the focusing points 281 and 291 of the laser beams 28 and 29 on the front surfaces 201 of the two scheduled processing lines 202-1 adjacent to each other on the workpiece 200, and irradiates with the laser beams 28 and 29 the front surfaces 201 of the two scheduled processing lines 202-1 adjacent to each other and extending in the first direction 211 of the workpiece 200. In this manner, in the first embodiment, in the laser processing step 1003, the focusing point 281 of the first laser beam 28 and the focusing point 291 of the second laser beam 29 move on the front surfaces 201 of the two scheduled processing lines 202-1 adjacent to each other among the plurality of scheduled processing lines 202-1 extending in the first direction 211, as illustrated in FIG. 7.

In the first embodiment, in the laser processing step 1003, when the laser processing apparatus 1 irradiates with the laser beams 28 and 29 the front surfaces 201 of the two scheduled processing lines 202-1 adjacent to each other, among the plurality of scheduled processing lines 202-1 extending in the first direction 211, to apply ablation processing, and then, the processing control unit 101 of the controller 100 controls to relatively move the light focusing unit 27 of the laser beam irradiation unit 20 and the workpiece 200 held by the holding unit 10 in the Y-axis direction by a distance twice the index value 213 (hereinafter, referred to as indexed feed). Subsequently, the laser processing apparatus 1 irradiates with the laser beams 28 and 29 the front surfaces 201 of the next two scheduled processing lines 202-1 adjacent to each other and extending in the first direction 211 of the workpiece 200.

In this manner, in the laser processing step 1003 in the first embodiment, the processing control unit 101 of the controller 100 repeats the irradiation of the laser beams 28 and 29 onto the front surfaces 201 of the two scheduled processing lines 202-1 adjacent to each other and extending in the first direction 211 and the indexed feed, so as to achieve irradiation with the laser beams 28 and 29 onto all the scheduled processing lines 202-1 extending in the first direction 211 of the workpiece 200. Furthermore, in the laser processing step 1003 in the first embodiment, after irradiation with the laser beams 28 and 29 onto all the scheduled processing lines 202-1 extending in the first direction 211 of the workpiece 200, the processing control unit 101 of the controller 100 controls the movement unit 30 to rotate the holding unit 10 by 90 degrees about the axis and irradiates with the laser beams 28 and 29 the scheduled processing lines 202-3 extending in the second direction 212, similarly to the scheduled processing lines 202-1 extending in the first direction 211. In the laser processing step 1003 in the first embodiment, the laser processing apparatus 1 irradiates with the laser beams 28 and 29 all the scheduled processing lines 202-1 and 202-2 of the workpiece 200 held by the holding unit 10 to form laser processed grooves (not illustrated).

Hereinafter, of the scheduled processing line 202-1 and 202-2, one of the scheduled processing line 202-1 and 202-2 simultaneously irradiated with the laser beams 28 and 29 in the laser processing step 1003 is referred to as a first scheduled processing line, and the other is referred to as a second scheduled processing line. For this reason, in the first embodiment, in the laser processing step 1003, the focusing point 281 of the first laser beam 28 is positioned on the first scheduled processing line 202-1 and 202-2, while the focusing point 291 of the second laser beam 29 is positioned on the second scheduled processing line 202-1 and 202-2 different from the first scheduled processing lines 202-1 and 202-2, so that the first laser beam 28 is emitted along the first scheduled processing lines 202-1 and 202-2 while the second laser beam 29 is emitted along the second scheduled processing lines 202-1 and 202-2.

### Cleaning Step

The cleaning step 1004 is a step of cleaning the front surface 201 of the workpiece 200. In the laser processing apparatus 1 in the cleaning step 1004, the processing control unit 101 of the controller 100 controls units such as the movement unit 30 to move the holding unit 10 to the loading/unloading region, stops suction holding of the holding surface 11 of the holding unit 10 in the loading/unloading region, and stops clamping of the frame 206 of the clamping portion 12.

In the laser processing apparatus 1 in the cleaning step 1004, the processing control unit 101 of the controller 100 controls the transfer unit 50 to place the workpiece 200 from the holding unit 10 onto the holding surface of the spinner table 41 of the cleaning unit 40. In the laser processing apparatus 1 according to the first embodiment in the cleaning step 1004, the processing control unit 101 of the controller 100 sucks and holds the back surface 204 side of the workpiece 200 onto the holding surface of the spinner table 41 via the tape 205, clamps the frame 206 using the clamping portions 43, rotates the spinner table 41 about the axis, and drips the cleaning liquid from the cleaning nozzle 42 to the center of the workpiece 200 on the front surface 201 side.

The dripped cleaning liquid flows from the center side toward the outer peripheral side on the front surface 201 of the workpiece 200 by the centrifugal force generated by the rotation of the spinner table 41, and cleans the front surface 201 of the workpiece 200. In the cleaning step 1004, the laser processing apparatus 1 according to the first embodiment supplies cleaning liquid for a predetermined time while rotating the spinner table 41 about the axis to clean the front surface 201 of the workpiece 200.

As described above, the laser processing apparatus 1 and the laser processing method according to the first embodiment include: the splitter element 25 that splits the laser beam 21 generated by the oscillator 22; and the rotation mechanism 26 that rotates the splitter element 25 about the optical axis 251 passing through the center of the splitter element 25. With this configuration, the laser processing apparatus 1 and the laser processing method according to the first embodiment can change the interval 220 between the focusing points 281 and 291 of the laser beams 28 and 29 split by the rotation of the splitter element 25 about the optical axis 251 by the rotation mechanism 26.

As a result, the laser processing apparatus 1 and the laser processing method according to the first embodiment have an effect of being able to adjust the interval 220 between the focusing points 281 and 291 of the laser beams 28 and 29 with a simple mechanism, namely, the rotation mechanism 26 that rotates the splitter element 25 about the optical axis 251, and an effect of achieving simplification of the mechanism of adjusting the interval 220 between the focusing points 281 and 291 of the laser beams 28 and 29.

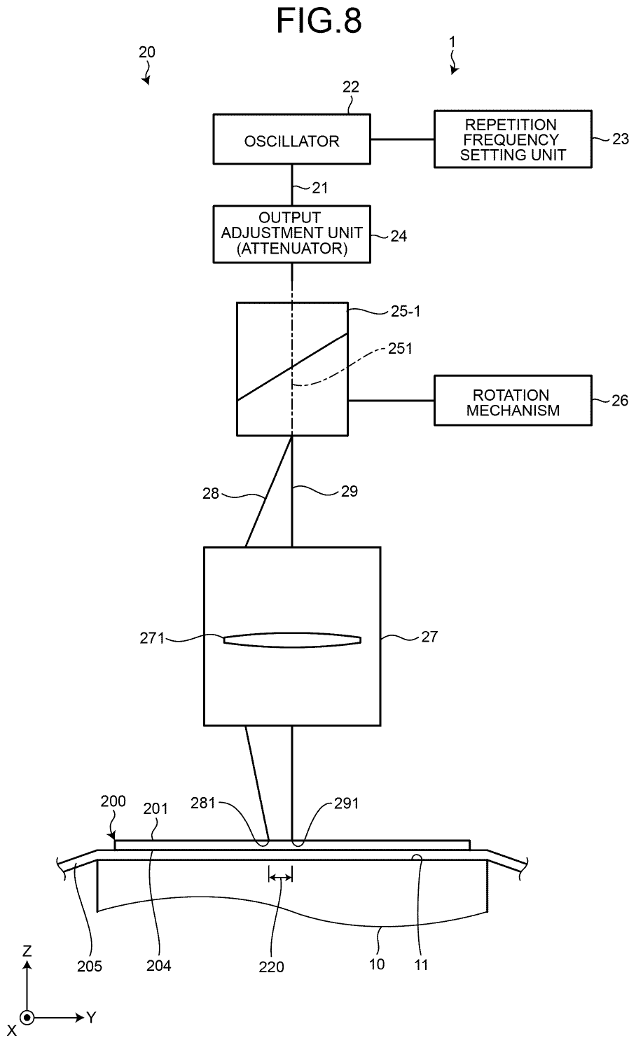

In the present disclosure, the splitter element 25-1 is not limited to the diffractive optical element, and may be, for example, a polarizing prism that splits the laser beam 21 into the first laser beam 28 and the second laser beam 29, such as a Rochon prism or a Wollaston prism as illustrated in FIG. 8. FIG. 8 is a view illustrating a modification of the laser beam irradiation unit illustrated in FIG. 3, and the same portions as those of the first embodiment are denoted by the same reference numerals, and description thereof is omitted. The laser beam irradiation unit 20 illustrated in FIG. 8 is the same as that of the first embodiment except that the splitter element 25-1 is a polarizing prism.

In the present disclosure, the laser processing apparatus 1 may include a unit that forms a protective film on the front surface 201 of the workpiece 200 before irradiating the workpiece 200 with the laser beams 28 and 29. In this case, it is desirable to coat the entire front surface 201 of the workpiece 200 with a protective film by applying a liquid water-soluble resin (for example, HogoMax (registered trademark) manufactured by DISCO Corporation) such as polyvinyl alcohol (PVA) or Polyvinylpyrrolidone (PVP) to the front surface 201 of the workpiece 200 and drying the liquid water-soluble resin. The unit for forming the protective film may be implemented by the cleaning unit 40 including a nozzle for supplying the liquid water-soluble resin to the front surface 201 of the workpiece 200, or may be implemented by a unit different from the cleaning unit 40.

According to the present disclosure, it is possible to achieve simplification of a mechanism of adjusting intervals between focusing points of laser beams.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A laser processing apparatus comprising:
a holding unit configured to hold a workpiece;
an oscillator configured to generate a laser beam;
a splitter element configured to split the laser beam generated by the oscillator into a first laser beam and a second laser beam;
a rotation mechanism configured to rotate the splitter element about an axis passing through a center of the splitter element; and
a focusing unit including a focusing lens configured to focus the first laser beam split by the splitter element onto the workpiece held by the holding unit and to focus the second laser beam split by the splitter element onto the workpiece held by the holding unit.

2. The laser processing apparatus according to claim 1, wherein the splitter element includes a diffractive optical element.

3. The laser processing apparatus according to claim 1, wherein the splitter element includes a polarizing prism.

4. The laser processing apparatus according to claim 1, further comprising a controller configured to control at least the rotation mechanism, the controller including
an index value registration unit configured to register an index value regarding an interval between a position of a focusing point of the first laser beam and a position of a focusing point of the second laser beam, and
an angle calculation unit configured to calculate a rotation angle of the splitter element based on the index value registered in the index value registration unit, wherein
the controller controls the rotation mechanism based on the rotation angle calculated by the angle calculation unit.

5. The laser processing apparatus according to claim 4, wherein
a plurality of scheduled processing lines extending in a first direction is set on the workpiece, and
the focusing point of the first laser beam is positioned on a first scheduled processing line, and the focusing point of the second laser beam is positioned on a second scheduled processing line different from the first scheduled processing line.

6. The laser processing apparatus according to claim 1, wherein the focusing unit forms the first laser beam in a direction perpendicular to the workpiece and forms the second laser beam in the direction perpendicular to the workpiece.

7. A laser processing method of processing a workpiece on which a plurality of scheduled processing lines extending in a first direction is set, the method comprising:
holding a workpiece by a holding unit;
performing laser processing along the scheduled processing lines on the workpiece by splitting a laser beam generated by an oscillator into a first laser beam and a second laser beam by a splitter element, and relatively moving a focusing unit and the holding unit in a first direction while focusing light on the workpiece held by the holding unit using the first laser beam and the second laser beam, the performing the laser processing including positioning a focusing point of the first laser beam on a first scheduled processing line, positioning a focusing point of the second laser beam on a second scheduled processing line different from the first scheduled processing line, and emitting the first laser beam along the first scheduled processing line while emitting the second laser beam along the second scheduled processing line; and
at least before performing the laser processing, adjusting an interval between the focusing point of the first laser beam and the focusing point of the second laser beam by rotating the splitter element based on a distance between the focusing point of the first laser beam and the focusing point of the second laser beam in a second direction orthogonal to the first direction.
